(19) United States
(12) Patent Application Publication
(10) Pub. No.: US 2004/0267563 A1
(43) Pub. Date: Dec. 30, 2004

(54) Implementing an effective medical treatment management program

(76) Inventors: Rebecca Dunn, Atlanta, GA (US); Rubby King, Dunwoody, GA (US)

Correspondence Address: THOMAS, KAYDEN, HORSTEMEYER & RISLEY, LLP/, BELLSOUTH I.P. CORP, 100 GALLERIA PARKWAY, SUITE 1750, ATLANTA, GA, 30339, US

(21) Appl. No.: 10/680,597

(22) Filed: Oct. 7, 2003

Related U.S. Application Data
(60) Provisional application No. 60/484,239, filed on Jun. 30, 2003.

(51) Int. Cl. G06F 17/60

(52) U.S. Cl. 705/2

(57) ABSTRACT

Preferred embodiments of the present invention provide a program, implemented by an employer, for assisting in the management of medical treatments associated with active and retired employees. In one example, among others, in a business environment, an employer creates an internal support network to operate a program for assisting in the management of medical treatments of individuals within the business environment, such as employees. Accordingly, the internal support network provides information resources on treating medical conditions and distributes the resources to individuals within the business environment who request assistance with regard to managing treatment of a medical condition. Further, participants in the program may be trained to provide personal assistance to an individual in understanding an information resource. Other methods and systems are also provided.

### CROSS-REFERENCE TO RELATED APPLICATION

This application claims priority to U.S. provisional application, having Ser. No. 60/484,239, filed Jun. 30, 2003, which is entirely incorporated herein by reference.

This application is related to copending U.S utility patent application entitled “Facilitating Effective Medical Treatment Management” filed the same day as the present application and accorded serial number ______, which is entirely incorporated herein by reference.

### TECHNICAL FIELD

The present invention is generally related to medical treatments and, more particularly, is related to management of medical treatments.

### BACKGROUND OF THE INVENTION

Everyone is susceptible at some level to being diagnosed with a disease or severe infirmity. For example, in the United States, men have about a 1 in 2 chance (50%) of developing cancer, and women have about a 1 in 3 chance (33%). Therefore, there are over 8 million people living in the United States with cancer.

Since an employer's business is dependent upon its employees, the well-being of an employee directly affects the well-being of a business. Accordingly, it is in the interest of an employer, such as a corporation, to provide the best resources available to promote the wellness of its employees. Typically, an employer may make some general informational resources available for the medical treatment of its employees. However, an employee who has been newly diagnosed with a disease, such as cancer, is likely to become confused and frustrated trying to determine how to assimilate this information concerning his or her medical condition. As a result, this may be detrimental, since the employee may have critical decisions that need to be made. In reciprocating fashion, it also becomes detrimental to an employer.

Thus, a heretofore unaddressed need exists in the industry to address the aforementioned deficiencies and inadequacies.

### SUMMARY OF THE INVENTION

Preferred embodiments of the present invention provide a program, implemented by an employer, for assisting in the management of medical treatments associated with active and retired employees. Such embodiments may be broadly summarized by the following steps. In a business environment, an employer creates an internal support network to operate a program for assisting in the management of medical treatments of individuals within the business environment, such as employees. Accordingly, the internal support network provides information resources on treating medical conditions and distributes the resources to individuals within the business environment who request assistance with regard to managing treatment of a medical condition. Further, participants in the program may be trained to provide personal assistance to an individual in understanding an information resource.

Other methods, features, and advantages of the present invention will be or become apparent to one with skill in the art upon examination of the following drawings and detailed description. It is intended that all such additional methods, features, and advantages be included within this description.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a flowchart describing functionality of one of a plurality of embodiments of the wellness management assistance program of the present invention.

FIG. 2 is a flowchart describing one of a plurality of embodiments of a process for the continuing updating and maintaining of information in a resource guide utilized in FIG. 1.

FIG. 3 is a flowchart describing one of a plurality of embodiments of a process for implementing, at a place of business, the wellness management assistance program of FIG. 1.

FIGS. 4-5 are flowcharts describing one of a plurality of embodiments for implementing, at a place of business, the wellness management assistance program of FIG. 1.

FIG. 6 is a flowchart describing the general operations performed within one of a plurality of embodiments of the wellness management assistance program of FIG. 1.

FIG. 7 is a block diagram describing one of a plurality of embodiments for implementing the functionality of the wellness management assistance program as described in FIGS. 1-6.

FIG. 8 is a block diagram describing one of a plurality of embodiments for an information network component of FIG. 7.

FIG. 9 shows one of a plurality of embodiments for a management component of FIG. 7.

### DETAILED DESCRIPTION OF THE PREFERRED EMBODIMENTS

Preferred embodiments of the wellness management assistance program of the present invention described herein include a program designed to provide support and resources to employees and family members affected by health conditions, such as cancer, among others. To a newly diagnosed employee, a severe infirmity such as cancer seemingly wants to take control of the life of the employee. Thus, embodiments of the wellness management assistance program of the present invention allows the employee to take control and manage himself or herself to wellness or at least to a better quality of life.

Further, preferred embodiments of the wellness management assistance program utilize experiences, talents, and developed skills of a business or corporation to enable a fellow employee to manage the treatment of his or her medical condition. Generally, embodiments of the wellness management assistance program provide a newly diagnosed person or family member with information; offer encouragement to the newly diagnosed person or family member; provide for an understanding of the disease and the options available; and explain the value of a support network in treating a medical condition.

Particularly, preferred embodiments of the wellness management assistance program may provide an employee who has been newly diagnosed with a medical condition, such as but not limited to cancer, an easy to use, comprehensive resource package that helps him or her gather and retain information pertinent to his or her specific condition. In addition, preferred embodiments of the wellness management assistance program may encourage the newly diagnosed individual to become an informed partner with his or her healthcare team; to understand the value of taking action and thus, taking control of his or her life by participating in treatment decisions; and to understand the role of a positive outlook in getting well. Correspondingly, embodiments of the wellness management assistance program are not intended to be a substitute for medical advice, a complete medical resource, a substitute for a second opinion, or a recommendation for any single institution, organization, or individual.

Embodiments of the wellness management assistance program preferably include at least two separate but related processes. The first process enables a newly diagnosed individual to actively and effectively manage his or her medical treatment by seeking assistance from an employer. (Note, medical diagnosis of the individual is performed independently of the wellness management assistance program.)

Typically, the newly diagnosed individual is a current or retired employee who has been personally diagnosed with a medical condition or is the primary caregiver of someone who has been diagnosed with a medical condition. The second process facilitates the continual updating and maintaining by an employer of current medical information that is being supplied in embodiments of the wellness management assistance program to a newly diagnosed individual.

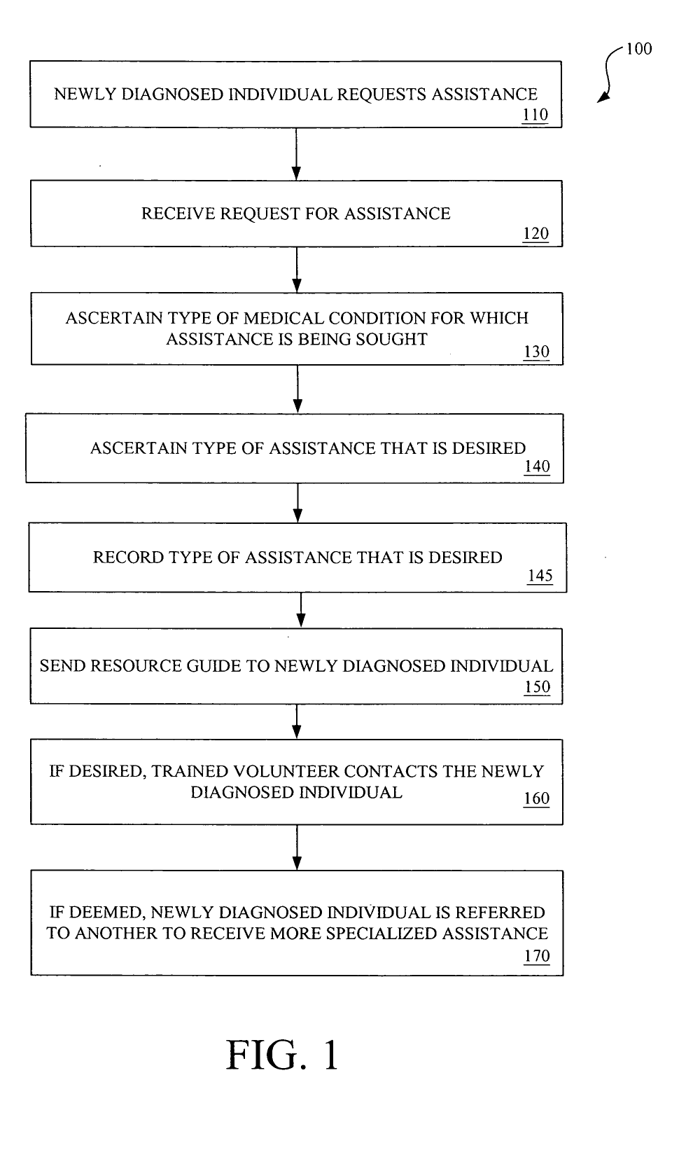

Referring to the first process, the flowchart of FIG. 1 shows selected functions of one of a plurality of embodiments of the wellness management assistance program 100 with respect to a newly diagnosed individual. First, in block 110, a newly diagnosed individual requests assistance from the wellness management assistance program. The newly diagnosed individual may have learned of the assistance provided by the wellness management assistance program 100 from a variety of communication channels, such as the person's place of work, the Internet, local media, word of mouth, etc.

In block 110, the request may be made in a variety of manners, such as placing a telephone call, sending an email, or making direct verbal communication to a representative of the program. Preferably, the newly diagnosed individual calls a toll-free telephone number that directs the person to a voice mail mailbox for the wellness management assistance program 100. Identification information concerning the identity of the individual, contact information for the individual, and type of medical condition associated with the individual is preferably provided in the communication.

For example, an outgoing message on a voice mailbox recording may be as follows:

Hello. Thank you for calling the wellness management assistance program. If you are calling to request information for a newly diagnosed individual, the following information is needed. Please leave your name. Please leave your mailing address including the state and zip code. Please leave your telephone number including the area code. Please leave the type of resource guide that you desire: breast cancer, colorectal cancer, prostate cancer, or our generic cancer resource guide.

If you are calling to volunteer to work with our wellness management assistance program, leave your name and telephone number, and a program representative will contact you within twenty-four hours. Thank you for calling.

Next, in block 120, a designated representative of the wellness management assistance program receives the communication from the newly diagnosed individual indicating that the individual seeks assistance. For telephone communication, the newly diagnosed individual may leave a message in a voice mailbox that is periodically reviewed by the designated representative of the program, such as an administrator or a program director. The manner or lines of communication between the newly diagnosed individual and program representative are secure and confidential. Further, to ensure confidentiality, the number of designated representatives that receive initial contacts from a newly diagnosed individual should be, preferably, limited to a small number.

Then, in block 130, a representative of the program, such as a program director, ascertains for what specific type of medical condition, such as colorectal cancer, the individual is seeking resources. Accordingly, the representative contacts the newly diagnosed individual to obtain this information, if this information has not been previously provided, such as communicated in a voice mail message or otherwise, in step 110. When attempting to contact the newly diagnosed individual, at this time or any other time, a representative of the program utilizes extreme caution in leaving messages on voice mail or in talking to another person, such as a receptionist, who is not the newly diagnosed individual. Unless the representative is talking directly with the newly diagnosed individual, reference to the wellness management assistance program is not mentioned, and the representative only identifies himself or herself as an employee of the employer. Further, upon talking to the newly diagnosed individual, the program representative should also assure the newly diagnosed individual that any disclosed information will be kept confidential by the program representative and any other representatives of the program.

Next, in block 140, the type of additional assistance that the newly diagnosed individual desires is determined. Typically, during the communication in block 130, the program representative also inquires into the individual's needs, which may include help in accessing useful information, such as local resources, Internet resources, etc.; meeting with a trained volunteer to assist in understanding a resource guide that is to be sent to the newly diagnosed individual; and an offering of emotional support, among others.

After contacting the newly diagnosed individual, the program director may be informed as to what kind of further assistance is needed, such as that involving a trained volunteer. Accordingly, the program director may record the status of assistance being provided for the newly diagnosed individual in a database or some other record keeping system, as shown in block 145. Then, a resource guide that is tailored to that medical condition is sent to the newly diagnosed individual as soon as possible, as shown in block 150.

If a resource guide is not available for a specific medical condition, then a resource guide with more general medical information may be provided to the newly diagnosed person that covers the general nature of the person's medical condition. To provide this information as quick a manner as possible, the resource guide material may be pre-prepared and pre-assembled. Therefore, a person in the support staff for the wellness management assistance program can easily package the material in a box, address the box to the newly diagnosed individual, and promptly place the box in the mail, for example. Each resource guide for a particular medical condition is intended to provide current and credible information concerning the relevant medical condition. The information contained in the resource guide is compiled and reviewed according to internal procedures that are specified by the wellness management assistance program.

Like technology, medical treatments are changing daily. Therefore, the resource guide may be viewed as a tool to help navigate a newly diagnosed individual through his or her medical treatment. Accordingly, the information provided within the resource guide touches on different areas of education. Consider, for example, a resource guide prepared for prostate cancer. Such a resource guide may explain the following: (1) What is prostate cancer? (2) What does it mean? and (3) What are the stages? Further, the resource guide for prostate cancer may also explain treatment options that are available, such as chemotherapy or radiation therapy.

In addition, a resource guide may provide information of relevant interest to a primary caregiver and family members, since the primary caregiver and family members undergo much stress and fatigue, both physically and emotionally. The resource guide might also contain helpful material on how the newly diagnosed person may tell others, such as a supervisor or co-workers, about his or her diagnosis. A list of other resources and sources of information that have been verified to be credible and reliable may also be provided to the newly diagnosed individual.

For example, with colorectal cancer, there is not a lot of information currently available that specifically addresses colorectal cancer. However, as part of the wellness management assistance program, credible information concerning colorectal cancer is ascertained and gathered and provided to a person who has been diagnosed with colorectal cancer. As part of one of a plurality of embodiments of the wellness management assistance program, information that is provided is routinely checked within the program to verify that the information is current and viable.

If the newly diagnosed individual requested assistance from a trained volunteer in block 140, the program director assigns a trained volunteer to contact the newly diagnosed individual and verify that the individual has received the resource guide that was mailed to the individual. Since the resource guide is received by the newly diagnosed individual in advance, the newly diagnosed individual can become familiar with the materials before determining whether the individual would like the trained volunteer to help the newly diagnosed individual navigate the contents of the resource guide.

Accordingly, in support of the resource guide, a trained volunteer may contact and meet with the newly diagnosed individual to help explain the resource material and to provide additional support, as shown in block 160. To provide effective assistance, the trained volunteer is instructed and taught how to interact with the newly diagnosed individual. However, if after meeting with the newly diagnosed individual, the trained volunteer determines that the newly diagnosed individual needs additional counseling or support from a more highly trained individual, then the trained volunteer may refer the newly diagnosed individual to another party or provide direction to the newly diagnosed individual on how to receive additional help, as shown in block 170. For example, the trained volunteer may refer an individual to a professional counselor or therapist or to another support group supported by the employer.

With the aid of the resource guide and additional resources, such as a trained volunteer, the newly diagnosed individual can learn vital factors that, in at least one embodiment, are important to managing and improving the person's wellness in regard to his or her medical condition. These include educating oneself about the particular medical condition; partnering with the healthcare team in determining a proper course of treatment; continuing to work and maintain work relationships, whenever possible; taking control of one's life; and maintaining a positive attitude. Newly developed skills may then be combined with pre-exisiting skills to effectively manage medical treatment. Particularly, many of the employees of a business or corporation have skill sets that can be easily transferred to managing themselves to wellness or others. Further, learning to be an active partner in one's treatment improves one's quality of life.

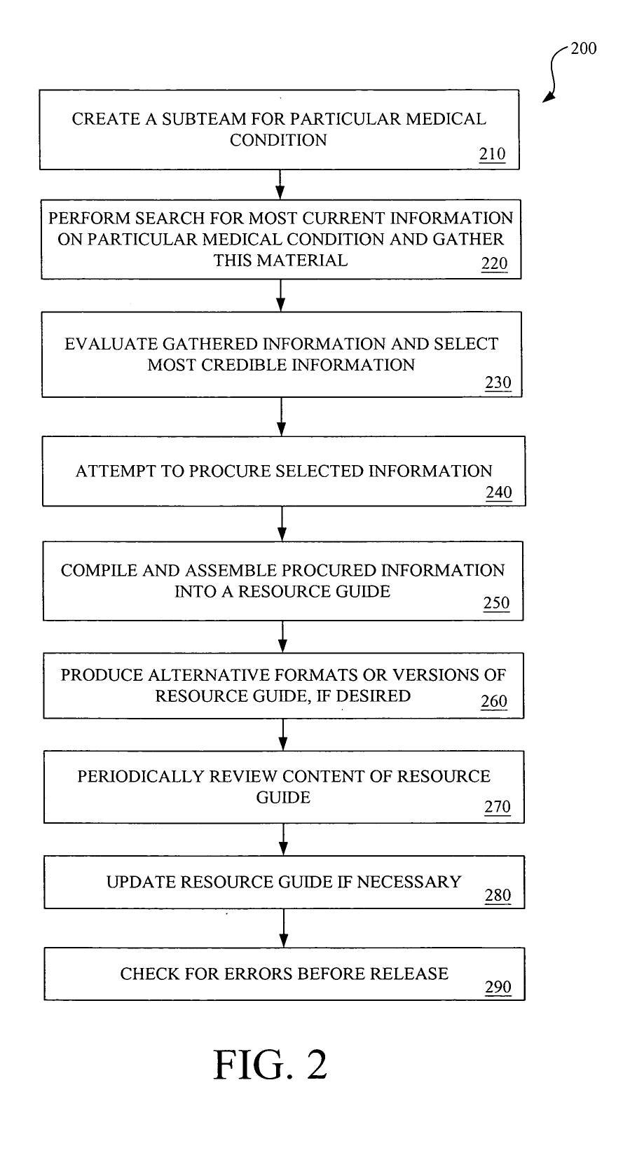

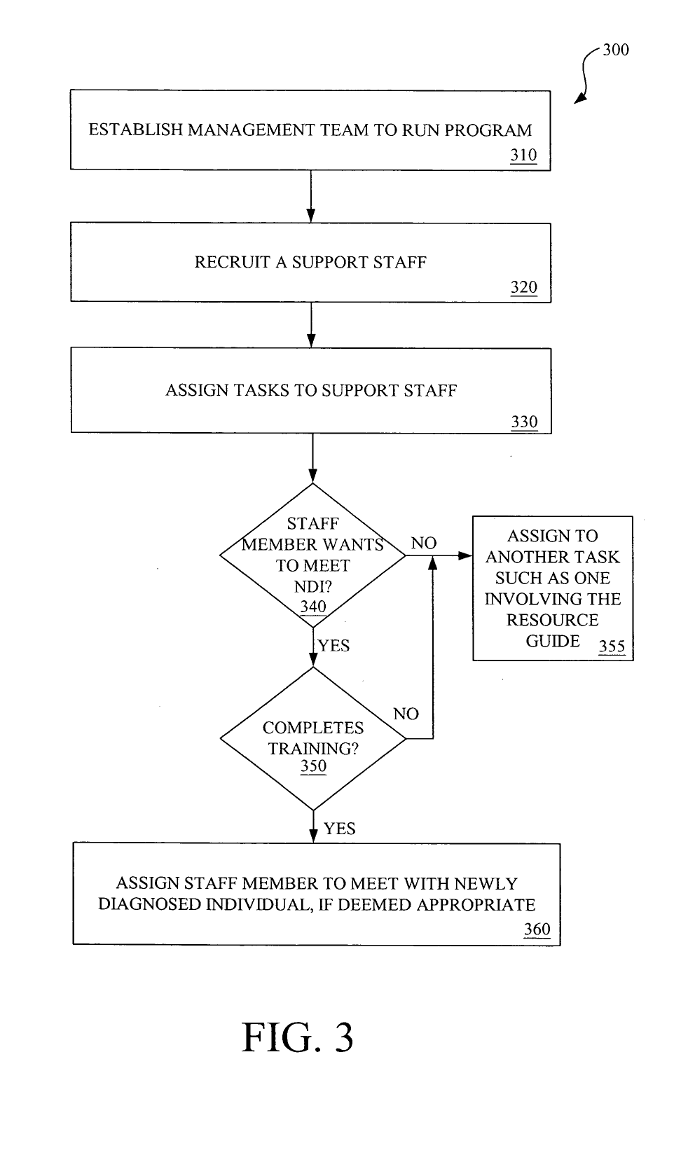

The second process in one of a plurality of embodiments of the wellness management assistance program involves the continuing updating and maintaining of information in the resource guide. One embodiment of such a process 200 is shown in FIG. 2. In block 210, a group of persons or “subteam” is created for a particular medical condition, such as breast cancer. Then in block 220, the subteam performs a search for the most current information on the particular medical condition. This search typically involves Internet web sites, books, periodicals, brochures, and other sources of medical information. Next, the information that is gathered from this search is then evaluated and reviewed by the subteam or some other group of persons within the program, such as a management team (as is later explained with regard to FIG. 3), as shown in 230. During the review, information that is deemed to be of high credibility, reliability, and timeliness is selected and targeted to be included in the resource guide for that particular medical condition. Accordingly, in block 240, the selected information is procured, if possible. For example, permission may have to be sought and obtained for desired information that is under copyright protection.

After all the material has been determined for a particular resource guide, the resource guide is assembled and an inventory of numerous copies of the guide is maintained, as shown in block 250. Oversight of the inventory status of a particular resource guide may be performed by the subteam or a separate “inventory” department or team. For example, a separate inventory department may track the inventories of all the resource guides for a multiplicity of medical conditions. Accordingly, this inventory department may procure the necessary articles, brochures, etc. to make further copies or versions of the resource guide as the number in inventory reduces. As noted previously, the assembly of resource guides may be performed by any persons designated by the director or another person with authority. Further, as depicted in block 260, alternative formats or versions of the resource guide may also be produced, such as an audio talking book or an electronic web page version.

Then, in block 270, on a periodic basis, the material in a particular resource guide is reviewed and verified to be current by generally reviewing the same source of materials in the initial search (e.g., books, brochures, periodicals, Internet, etc.). If the material is determined to not be current, then the material is updated, as shown in block 280. For example, each member of the subteam of a particular resource guide may be in charge of verifying and updating information for a section of the resource guide. After all updates and modifications have been made, the resource guide is checked for errors before the new version is approved ready for release to a newly diagnosed individual, as shown in block 290.

To conduct the research for a particular resource guide, to maintain it, and to assemble the resource guide typically involves manpower. Moreover, embodiments of the wellness management assistance program may necessitate an organizational structure or process, as a whole, to implement and manage the program. Accordingly, FIG. 3 shows one embodiment 300 for a process for implementing the wellness management assistance program at a place of business. In block 310, a management or core team is established to govern the wellness management assistance program. The core team, for example, may include a director that supervises all of the operations performed under the wellness management assistance program and delegates responsibilities to any of the other members of the core team or any other persons working on the wellness management assistance program. Also, in the core team, leaders of various subteams may be included. Typically, the core team will meet on a periodic basis to confer about the operations of the wellness management assistance program.

Also, at least one representative from a support staff may be included in the core team. Typically, the support staff performs routine tasks and helps maintain operations under the wellness management assistance program, such as assembling resource guides, answering telephones, mailing information, providing personal assistance, etc. Correspondingly, representatives from groups that provide financial assistance to the program may also be included. The core team may also feature an administrator who handles basic administrative duties, and a training coordinator who is in charge of educating and instructing the trained volunteers, among others. Further, a representative from any other support groups that are working in collaboration with the wellness management assistance program may also be included.

Each subteam is in charge of a particular project under the wellness management assistance program. For example, projects may involve preparing resource guide materials for a particular medical condition and providing training, among others. Further, different subteams may specialize in certain medical conditions such as prostate cancer, breast cancer, colorectal cancer, heart disease, etc. Accordingly, each leader of each subteam may be preferably someone who has had personal experience with the particular medical condition associated with that subteam, if applicable. For example, a prostate cancer survivor may be preferably the leader of a subteam for prostate cancer.

Next, at the initial formation of one of a plurality of embodiments of the wellness management assistance program, the recruitment of the support staff is performed, as shown in block 320. In one of a plurality of embodiments, volunteers composed of employees in the business or corporation primarily or entirely make up the support staff. Accordingly, different groups of persons may be targeted or recruited to be volunteers. Further, different groups of persons may be targeted to perform different tasks to support the wellness management assistance program.

Active employees may be informed of the opportunity to volunteer via common business communication channels, such as a newsletter, email, outside media, presentations, or word of mouth, among others. Further, active employees that do volunteer may be placed in positions of higher responsibility than non-active employees, since active employees may be generally expected to have a higher sense of obligation and duty to his or her employer and the employer's wellness management assistance program. In a similar manner, active employees may also be easier to manage. Diversely, non-active employees may be used for more routine tasks such as managing and maintaining inventory of the resource guides. One potential source of non-active volunteers for such a task is retired employees. For instance, there is often a pre-existing association for retired employees that performs such volunteer initiatives in the community that may be tapped.

Other sources for obtaining volunteers are internal special interest groups or memberships within a business or corporation. For example, a club or membership in a corporation may be founded around a certain ethnic background or common trait or interest. Therefore, the members of that club may be willing to be volunteers in one of a plurality of embodiments of the wellness management assistance program, especially if it is shown that an interest of that club is met by a wellness management assistance program. For example, if a corporation has an organization specializing in women's issues and concerns, then that organization may be willing to volunteer to work on a breast cancer subteam in the wellness management assistance program, since breast cancer is of concern to women. Alternatively, the organization may also be willing to give financial assistance. Accordingly, it may be necessary to encourage involvement of an interest group by showing how a wellness management assistance program benefits its constituency. For instance, participation by retired employees may be increased in a wellness management assistance program by pointing out that retired employees have a higher percentage of being diagnosed with certain medical conditions (e.g., cancer) than active employees do.

Next, in block 330, after a person has expressed a desire to be a part of the support staff for the wellness management assistance program, the person is assigned a task to perform. Accordingly, the program director or someone to whom the program director has delegated responsibilities, inquires of the person and determines what type of available tasks the person is interested in performing and for what particular subteam the person may be interested in working. The director or his or her delegate takes the person's interests under advisement and then assigns the person to a particular subteam and a particular task. If the person has expressed an interest in meeting with newly diagnosed individuals (NDIs), then a training coordinator may also perform a preliminary interview of the candidate over the telephone to determine if the candidate appears to be a good fit for that task, as shown in block 340. For example, qualities involving interpersonal skills, patience, sensitivity, demeanor, and emotional stability may be considered, among others. If the candidate appears to be a good fit, the candidate shall undergo training and instruction. If no interest has been expressed or if the candidate does not complete training, the candidate is assigned to another subteam, such as to one of the subteams dedicated to preparing a particular resource guide. Even though a candidate completes training, he or she might still not be assigned to help with a newly diagnosed individual, if in the discretion of the program director, or delegate, the candidate is not ready or appropriate for the task. It may be preferred that active employees may be used at the more demanding position of a trained volunteer.

In a similar manner as the resource guide, the training procedures and materials may be initially developed and supervised by the core team. To aid in development of the training materials/procedures and resource guide materials, focus groups may be formed to review the materials in order to learn what proposed materials/procedures are well received or not and to also learn what other materials/procedures are desired. Typically, training material includes various topics from (1) how many number of telephone attempts should the trained volunteer attempt to make to his or her assigned newly diagnosed person; (2) to encouraging the individual to bring along another person to a meeting if the individual desires; (3) to considering what types of questions to ask the individual; (4) to building a relationship and the volunteer's credibility with the newly diagnosed person; (5) to proper listening techniques, etc. Also, for training purposes, practice exercises may also be provided. In addition, candidates who undergo training are also encouraged to answer questionnaires to provide feedback about the training. Also, individuals who receive assistance are also encouraged to provide feedback. Feedback from the questionnaires may be considered in improving training practices and procedures.

Upon completion of the training program, as shown in block 350, a trained volunteer is eligible to be assigned to a newly diagnosed person. Accordingly, when a newly diagnosed individual indicates that he or she would like to meet with a trained volunteer, a designated person, such as the director, assigns a trained volunteer to meet with the newly diagnosed person, as shown in block 360. Accordingly, it is up to the director's discretion to select the trained volunteer and match up the trained volunteer with the newly diagnosed individual. The level of involvement between the trained volunteer and newly diagnosed individual should typically be established by the wants and needs of the diagnosed individual. Preferably, the trained volunteer has been previously educated about the medical condition of the newly diagnosed individual or has personal experience with the disease, such as that of survivors. Besides developing trained volunteers that meet with newly diagnosed individuals, the research, creation, and maintenance of informational materials is the other primary support role needed for embodiments of the wellness management assistance program, as shown in block 355, and previously discussed with regard to FIG. 2.

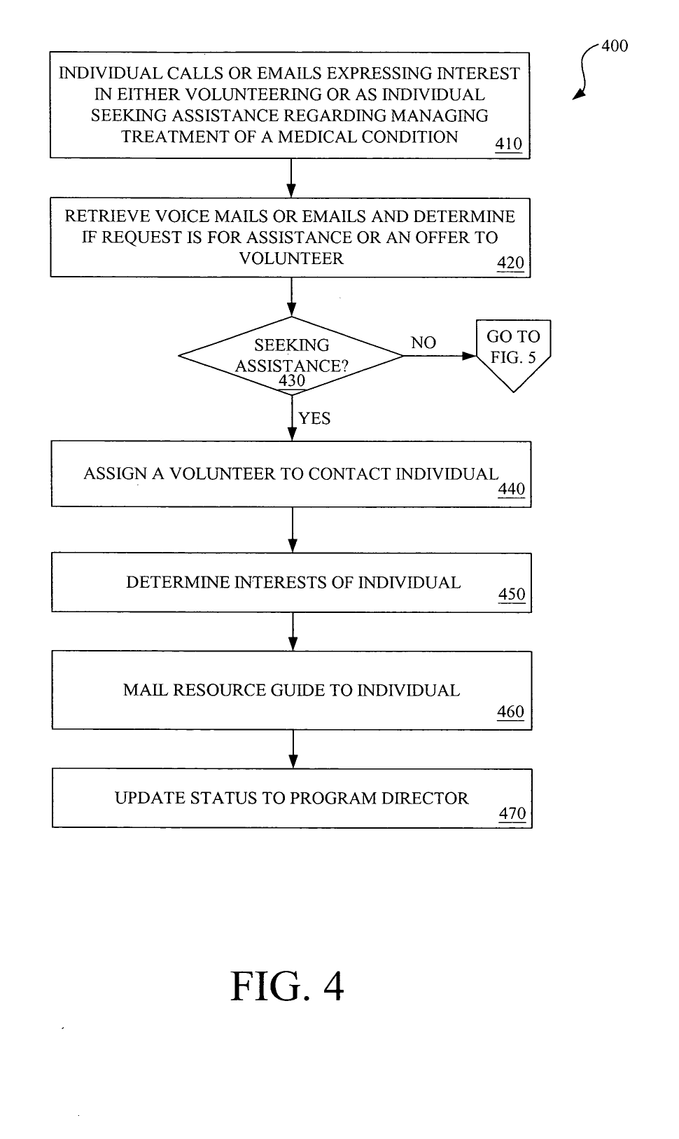

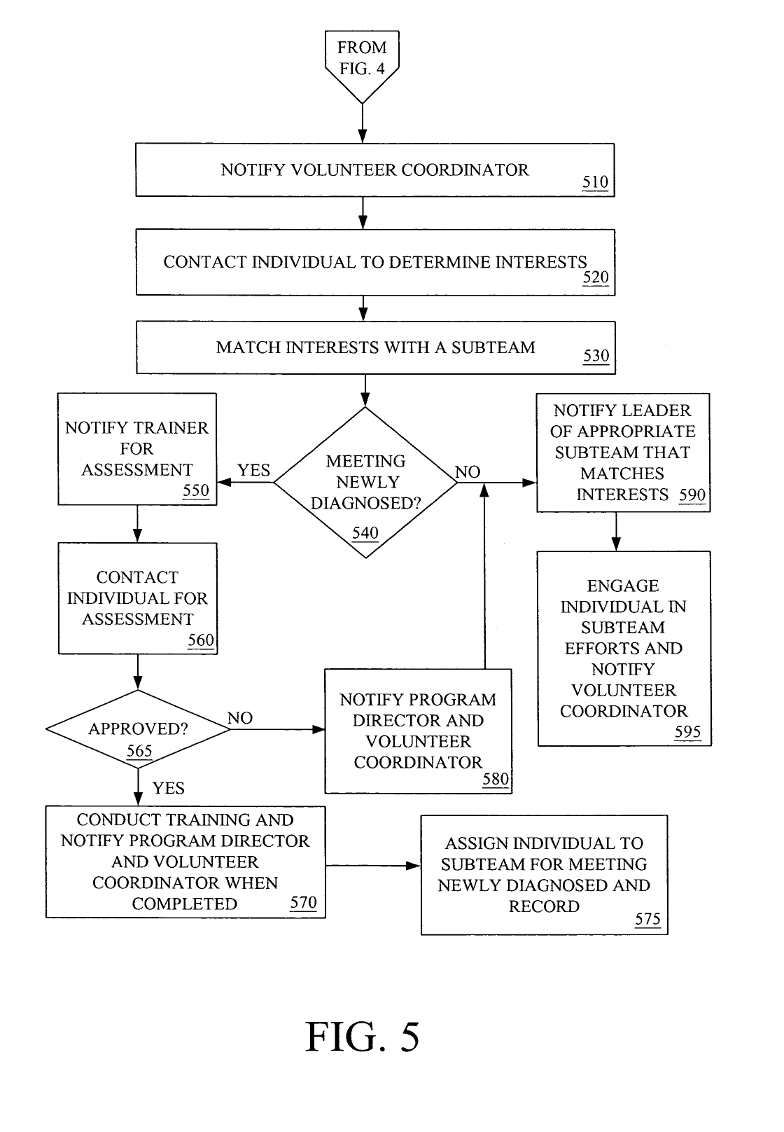

For a more detailed representation of one embodiment 400 for implementing a program for assisting in medical treatment management within a business environment, consider FIGS. 4-5. First, in block 410, an individual contacts the program (e.g., places a telephone call and leaves a voice mail, writes an email, etc.) expressing an interest in either volunteering to work in the program or requesting assistance from the program. Next, in block 420, the communication from the individual is retrieved by an administrator, for example, and the interest of the individual is determined from the communication, if possible. If it is determined that the individual is requesting assistance, the program director assigns a volunteer to contact the individual, as shown in block 440. The volunteer determines the particular medical condition with which the individual is concerned and determines the type of assistance or needs that are desired or required by the individual, as shown in block 450. Once the particular medical condition and the individual's interests are determined, the volunteer informs the program director, as shown in block 460. Then, the individual is promptly sent a medical resource guide for the relevant medical condition, as shown in blocks 470. Further, after the resource guide is sent, the trained volunteer may also contact the individual and verify the receipt of the resource guide.

If the initial communication of the individual is determined to be an offer to work in the program, a volunteer coordinator is notified by the administrator, for example, as shown in blocks 430 and 510 in FIGS. 4 and 5. Referring to FIG. 5, the volunteer coordinator determines the interests of the individual with regard to the type of work the individual would like to perform for the program, as shown in block 520. Then, the volunteer coordinator attempts to match the interests of the individual with a support team or subteam, as shown in block 530. For example, if the individual expresses an interest in meeting with individuals who have been or are primary caregivers of someone who has been newly diagnosed with a medical condition, then the training coordinator (“trainer”) is notified, as shown in blocks 540-550. The trainer coordinator, once notified, contacts the individual, typically via the telephone, and talks to the individual to determine whether the individual is a good candidate to personally meet with persons who have been newly diagnosed with medical conditions, as shown in block 560. If so, as shown in blocks 565-570, the training coordinator trains the individual and upon completion of training, notifies the volunteer coordinator and the program director that the individual has completed training. Next, in block 575, the program director assigns the individual to the subteam for meeting with the newly diagnosed and records the assignment in a record keeping system, so that the program director may call upon the individual to meet with the newly diagnosed, when desired.

If the training coordinator does not approve the individual to meet with the newly diagnosed, the training coordinator notifies the program director and volunteer coordinator so that the individual may be assigned to another subteam, as shown in block 580. For example, other subteams may involve resource guide assembly; ordering of materials; maintenance of breast cancer resource guide; maintenance of colon cancer resource guide; maintenance of prostate cancer resource guide; prostate cancer research; colon cancer research; breast cancer research; publicity and communications, etc.

Accordingly, in blocks 530, 540, and 590, for those who do not have an interest in meeting with the newly diagnosed or have been deemed to not be suited to meet with the newly diagnosed, the volunteer coordinator attempts to match the interests of the individual with another subteam. After a match has been determined, the leader for the chosen subteam is notified. Then, the leader contacts the individual and engages the individual in the activities of the chosen subteam, as shown in block 595. After the individual has been contacted, the volunteer coordinator is notified.

Preferred embodiments of the weliness management assistance program of the present invention are beneficial to an employer by improving the retention, morale, and productivity of employees. Moreover, preferred embodiments of the wellness management assistance program improve the wellness of a newly diagnosed individual by helping the newly diagnosed individual manage the treatment of his or her medical condition. Much of the challenge with a newly diagnosed individual of a medical condition is knowing where to start, how to assimilate, how to evaluate, and how and if all of the available medical information applies. Therefore, embodiments of the wellness management assistance program may meet that challenge by filling that gap between diagnosis and treatment. In other words, embodiments of the wellness management assistance program generally package information in such a way that it facilitates and expedites the learning process for the newly diagnosed person. Further, the learning fostered and experiences obtained by other members involved in embodiments of the wellness management assistance program provides strength, hope, and understanding for the newly diagnosed individual.

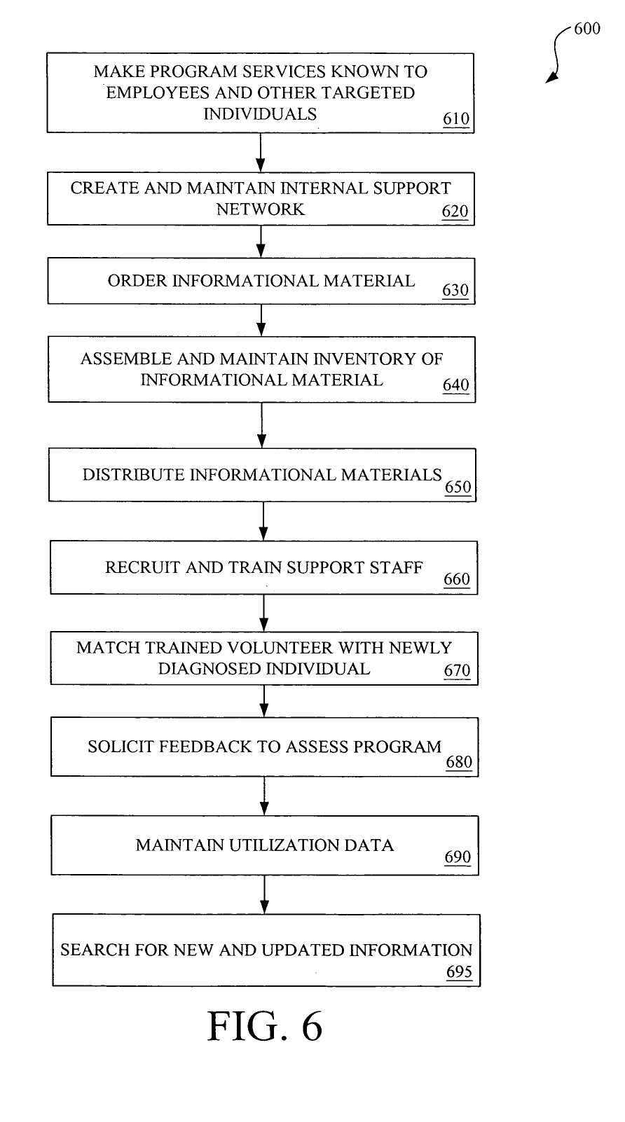

As an overview, FIG. 6 is a flowchart of the general operations 600 performed within one of a plurality of embodiments of the wellness management assistance program and overseen by the core team. In block 610, the services of the program are publicized and made known to persons who may need its services or alternatively, may want to offer their services as volunteers. Also, an internal support network is created and maintained to support the operations of one of a plurality of embodiments of the wellness management assistance program, as shown in block 620. Further, informational materials that are utilized in preparing the resource guides, training materials, etc. are ordered, as shown in block 630. The support network, for example, may be involved in maintaining an inventory of help or informational material, such as by compiling resource guides; assembling resource guides; and distributing such informational material to the necessary persons, as shown in blocks 640-650. Accordingly in block 660, recruiting and the training of volunteers is performed to staff the support network. Volunteers that have been appropriately trained are subsequently matched and assigned with one or more newly diagnosed individuals, as shown in block 670. For example, among others, a trained volunteer of the same gender and general age as that of the newly diagnosed individual may be assigned.

From both volunteers and newly diagnosed individuals, feedback is continually sought and solicited to assess the effectiveness of the program, as depicted in block 680. Further, in block 690, utilization data may be maintained to help assess program effectiveness. For example, utilization data (such as that involving gender, age, medical condition being treated, state of residence, etc.) of the individual receiving assistance may be kept. Next, in block 695, research is ongoing to provide new and updated medical information for resource guides.

Additional aims of preferred embodiments of the wellness management assistance program include the introduction of the management plan to all employees and retirees of a business, including a corporation that presides in several states (or countries) and the dispersal of the resources of a wellness management assistance program to, preferably, all employees as soon as possible after a diagnosis of a severe medical condition. Through the available resources, embodiments of the wellness management assistance program should provide needed information and support through peer volunteers. Additionally, some general information may be made available to the general work population at large or the public. For example, information on disease prevention or information on how to communicate with a newly diagnosed co-worker or subordinate may be available in a variety of forums, including a web site. Also, individual informational guides may be distributed to the newly diagnosed individual, fellow employees, or a supervisor, as the case may be.

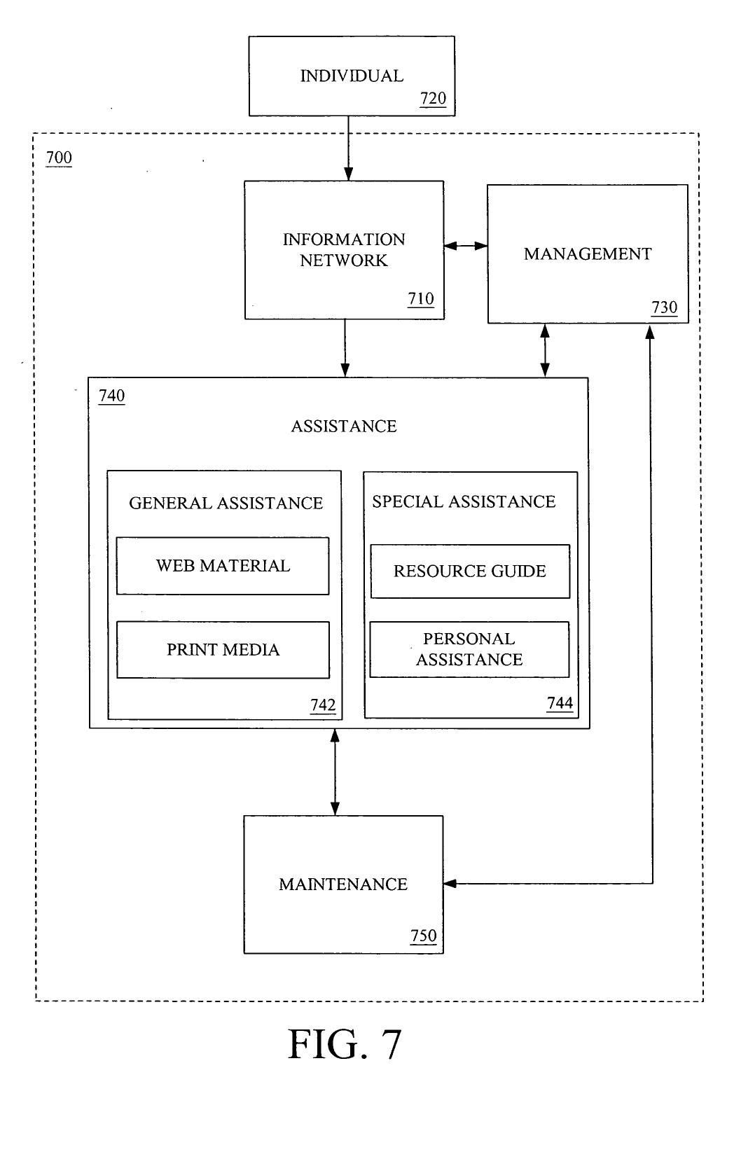

FIG. 7 is a block diagram showing one embodiment of component architecture for implementing the functionality of the wellness management assistance program as described in FIGS. 1-6. As shown in FIG. 7, one embodiment 700 of a system for implementing the wellness management assistance program comprises an information network 710 that is utilized by an individual 720 to communicate with persons in the wellness management assistance program 100 and to receive information provided by the wellness management program 100, as described with regard to FIGS. 1 and 4-6.

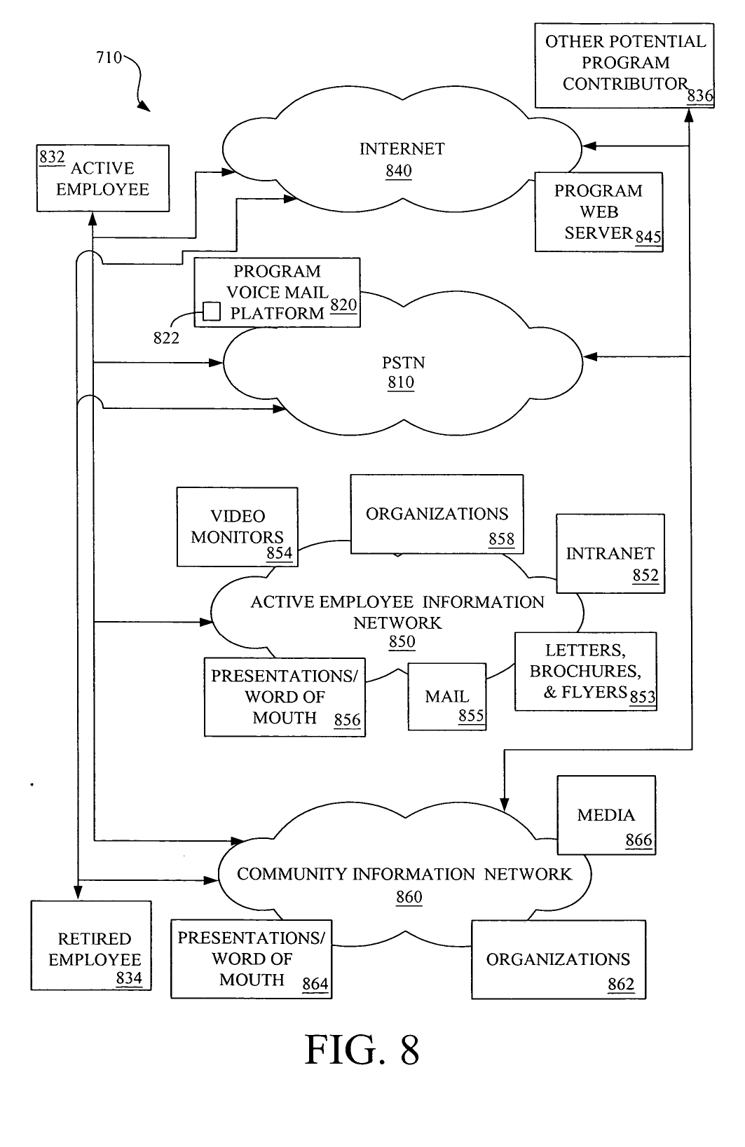

Accordingly, FIG. 8 is a block diagram describing one embodiment of an information network 710 of FIG. 7. In FIG. 7, the information network 710 of the wellness management assistance program has one or more telephones (not shown) that are connected to a telephone network 810 (e.g, public switched telephone network). Also, a voice mail platform 820 is connected to the telephone network 810 and accessible from other telephones connected to the telephone network 830. The voice mail platform 820 contains a mailbox 822 for the wellness management assistance program 100 so that an individual 832, 834, 836 may call the phone number for the mailbox 822 of the wellness management program 100 to listen to an outgoing message from a representative of the program and can also leave a message of his or her own to the representative of the program, as previously mentioned with regard to FIGS. 1 and 4.

For example, an active employee 832 or a retired employee 834 (of the employer that is employing the wellness management assistance program) may attempt to establish telephone contact with a representative of the program to seek assistance, to volunteer his or her services, to offer financial support, etc. Accordingly, a person who is not an active employee 832 or a retired employee 834 may also attempt to establish telephone communications with a representative of the program to offer his or her services to the program, for example.

In a similar manner, an individual 832, 834, 836 may also establish communication with the wellness management assistance program 100 by using a computing device (not shown) that is connected to the Internet 840. Therefore, an individual who is seeking assistance from the wellness management assistance may attempt to contact the program, via the computing device connected to the Internet 840. One method of Internet communication, among others, is email.

Further, in some embodiments, information is provided by the wellness management assistance program 100 on the World Wide Web. Accordingly, the wellness management assistance program 100 may offer a web site that is accessible by a web server 845 on the Internet 840. As previously described, web pages on the program web site may contain helpful information about the wellness management assistance program, in general, such as the telephone number(s) for directly communicating with representative(s) of the program or for leaving a voice mail message (via the voice mail platform 820).

In addition, resource guide material may be provided on the web site or links to other sources of information. Also, information contained on the web site may be general information made available to the general work population at large or the public, such as information on disease prevention. Further, general information about the wellness management assistance program may be provided such as information regarding how a person may seek assistance from the program, how one may volunteer for the program, how one may provide charitable contributions, etc.

Another aspect of some embodiments of the information network 710 involves an information network for active employees 850. Typically, active employees of the employer implementing the wellness management assistance program 100 are privileged to channels of communication that are exclusive to the employer and its employees. For example, the employer may provide an Intranet network 852, newsletters, flyers, pamphlets, and brochures 853, video monitors 854, interoffice mail 855, etc. for providing information pertinent to the employer. Such communication channels may be utilized by the wellness management assistance program 100 to publicize the availability of the program to active employees 832, as shown. Further, the environment of the employer's workplace provides opportunities to learn about the opportunities within the program 100 by discussing the program with other employees 856, holding presentations 856 regarding the program 100, networking with other employee organizations, etc.

Next, persons 834, 836, who are not active employees (or family members of active employees) may also learn about the opportunities and resources available within the wellness management assistance program 100 from a community information network 860. For example, the wellness management assistance program may reach out to the community at large by networking with community organizations 862, making public presentations 864, providing news releases to the media 866, etc.

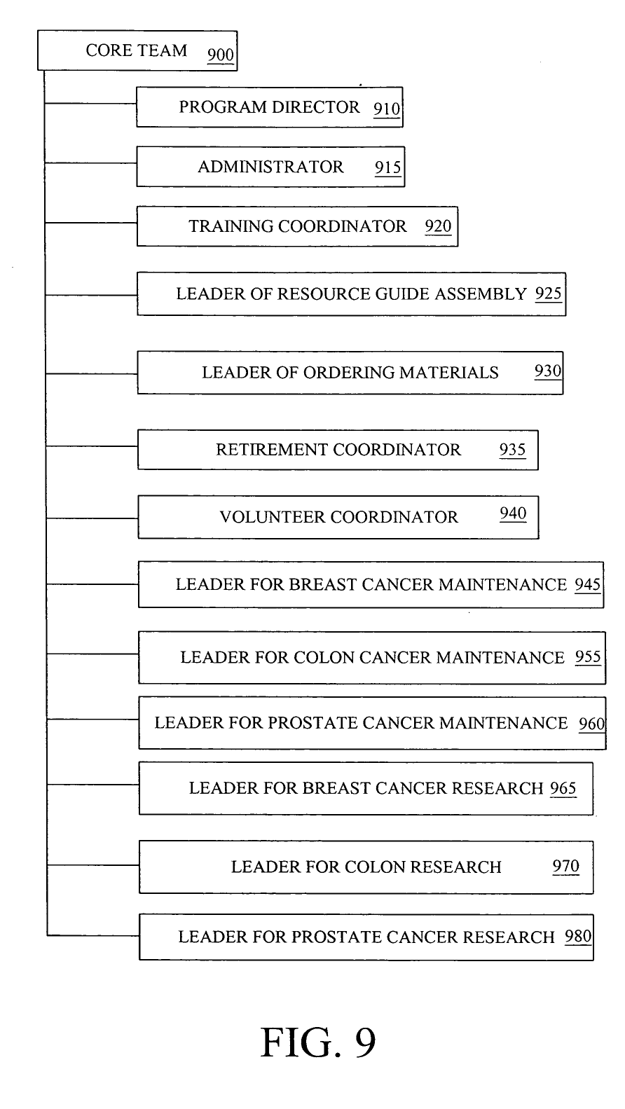

Referring back to FIG. 7, one embodiment, among others, of component architecture for implementing the functionality of the wellness management assistance program 700 also includes a management component 730, as previously described with regard to FIG. 3. The management component 730 involves a management or core team that oversees the operations of the wellness management assistance program 100. FIG. 9 shows one embodiment of the core team for the management component 730 in FIG. 7.

As shown in FIG. 9, the core team 900 includes a program director 910 that is the primary manager of the program 100. To help with regular core operations, the core team 900 also includes an administrator 915, a training coordinator 920, a leader of the resource guide assembly subteam 925, and a leader of the subteam 930 for ordering resource guide materials. A volunteer coordinator 935 that helps manage volunteers who are active employees is included, along with a retirement coordinator 940 who helps manage volunteers that are retired employees.

Leaders of various subteams are also included in the core team 900. For example, leaders of the subteams responsible for maintaining the resource guides for various medical conditions, such as breast cancer 945, colon cancer 955, prostate cancer 960, etc. are included. Further, leaders of various subteams responsible for performing research for various medical conditions, such as breast cancer 965, colon cancer 970, prostate cancer 980, etc. are also included.

As previously described, the core team 900 of the management component 730, in FIG. 7, is responsible for managing the assistance component 740 of the wellness management assistance program 700 to an individual 710. In one embodiment, the assistance component 740 may be viewed as having two sub-components. One sub-component is a general assistance component 742 that provides general information, via web pages, brochures, pamphlets, etc., that is disseminated or made available in mass to employees and possibly the public at large. The general information may include material on medical care, tips, preventive measures, etc. in addition to material on how to establish program contact and/or take advantages of opportunities within the program 100 (e.g, telephone numbers, points of contact, services offered, volunteer opportunities, etc.). The other sub-component, in FIG. 7, is a special assistance component 744 for providing assistance directed to the particular needs of an individual 720 that has requested assistance from the program 100. For example, the special assistance component 744 may provide resource guide materials for particular medical conditions, personal assistance from a trained volunteer, referrals to another support program, etc., as previously described in regard to FIGS. 1 and 4.

In addition, the core team 900 of the management component 730 oversees operation of a maintenance component 750 of the wellness management assistance program 700. The maintenance component 750 provides continual support services for the wellness management assistance program 700. Such services include resource guide upkeep (e.g., performing research activities, ordering materials, assembling materials, etc.), recruiting, and training, as previously described in reference to FIGS. 2-3 and 5-6.

Any process descriptions or blocks in flow charts should be understood as representing steps in the process, and alternate implementations are included within the scope of the preferred embodiment of the present invention in which steps may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. For example, the wellness management assistance program may provide assistance for the treatment of medical conditions than are not specifically mentioned herein. Accordingly, many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for implementing a wellness management program within a business environment, comprising the steps of:
recruiting a staff of persons from the business environment to implement the wellness management program;
training the staff to perform services involved in implementing the wellness management program; and
announcing the availability of the program within the business environment.

2. The method of claim 1, wherein the business environment is a corporation.

3. The method of claim 1, further comprising the step of:
collaborating with another program that offers a different type of assistance within the business environment; and
referring an individual that may need the different type of assistance to the other program.

4. The method of claim 1, wherein the staff comprises at least a management team and a support team.

5. The method of claim 4, wherein the management staff periodically confers to evaluate program operations.

6. The method of claim 4, wherein the support team is comprised of a plurality of groups of persons, the method further comprising the step of:
assigning a respective one a plurality of tasks to be performed to a respective one of the plurality of groups of persons.

7. The method of claim 6, wherein the management team comprises a respective leader of the respective one of the plurality of groups.

8. The method of claim 7, wherein the management team comprises at least one member who has survived a respective medical condition for which assistance concerning the respective medical condition is provided by the program.

9. The method of claim 7, further comprising the step of:
determining a particular one of the plurality of groups to assign a particular person.

10. The method of claim 9, the determining step comprising the step of:
ascertaining that the particular person desires to be assigned to a group that meets with individuals who request assistance from the program;
training the particular person to meet with individuals who request assistance from the program; and
assigning the particular person to the group that meets with individuals who request assistance from the program after completion of the training step.

11. The method of claim 10, further comprising the step of:
requesting feedback from the particular person with regard to the training step for training evaluation purposes.

12. The method of claim 10, further comprising the step of:
requesting feedback from the individuals who are assisted by the program for program evaluation purposes.

13. The method of claim 10, further comprising the step of:
requesting an independent party to assess the training step for training evaluation purposes.

14. The method of claim 10, the ascertaining step further comprising the step of:
interviewing the person to determine if the person is suitable for the training step.

15. The method of claim 9, the training step comprising the steps of:
receiving a request from the particular person for assisting individuals in managing the medical treatment of a medical condition;
assessing the particular person to determine if the particular person is approved to begin training; and
if approved, training the particular person from training materials in order to teach the particular person techniques for providing assistance in managing the medical treatment of a medical condition.

16. The method of claim 15, wherein the training materials are developed internally within the business environment.

17. The method of claim 15, wherein the particular person is an employee within the business environment.

18. The method of claim 1, further comprising the step of:
providing a manner of communication that an individual seeking assistance from the program may utilize to request assistance.

19. The method of claim 18, further comprising the step of:
providing a manner of communication that a person may utilize to offer to support operations of the program.

20. The method of claim 19, wherein the manner of communication for the individual seeking assistance from the program and the manner of communication for the person offering to support operations of the program involves leaving a message on a voice mailbox.

21. The method of claim 1, the recruiting step comprising the steps of:
publicizing the program within the business community;
recruiting a plurality of persons that share a particular interest to become volunteers in the program by showing that the program serves the particular interest; and
publicizing a manner of communication that an interested party may utilize to request to become a volunteer.

22. The method of claim 21, the recruiting step further comprising the step of:
recruiting a plurality of persons that share a common interest to give financial support to the program by showing that the program serves the common interest.

23. A method for implementing a wellness management program within a business environment comprising the steps of:
providing a means for a person to leave a voice mail message expressing an interest in supporting the program;
reviewing, via an administrator, a message by the person expressing an interest in supporting the program and notifying a volunteer coordinator;
contacting, via the volunteer coordinator, the person and determining the type of support that the person desires to provide in the program;
matching, via the volunteer coordinator, the person with a particular support team that performs a task that is compatible with the type of support; and
notifying, via the volunteer coordinator, a leader of the particular support team that the person has been assigned to the particular support team.

24. The method of claim 23, the matching step further comprising the steps of:
inquiring, via the volunteer coordinator, if the person wants to meet with an individual who is seeking assistance from the program;
if the person wants to meet with an individual who is seeking assistance from the program, assigning, via the volunteer coordinator, the person to a support team that meets with an individual who is seeking assistance from the program and notifying a training coordinator, wherein the training coordinator assesses whether the person is suitable to meet with an individual who is seeking assistance from the program;
if the person is deemed suitable to meet with an individual who is seeking assistance from the program, training, via the training coordinator, the person to meet with an individual who is seeking assistance from the program;
if the person is not deemed suitable to meet with an individual who is seeking assistance from the program, assigning, via the volunteer coordinator, to another support group that does not meet with an individual who is requesting assistance from the program; and
if the person does not want to meet with an individual who is seeking assistance from the program, assigning the person to another support group that does not meet with an individual who is requesting assistance from the program.

25. A method for implementing a wellness management program within a business community comprising the steps of:
providing a means for an individual to leave a voice mail message expressing an interest in seeking assistance from the program;
reviewing, via an administrator, a message by the individual expressing an interest in seeking assistance from the program for a particular medical condition and notifying a program director of the interest expressed by the individual;
sending medical information regarding the particular medical condition to the individual;
assigning, via the program director, a member of a support team that meets with a person seeking assistance from the program to contact the individual;
contacting, via the member of the support team, the individual to determine if the individual received the medical information;
determining, via the member of the support team, if the individual would like assistance in understanding the medical information; and
informing, via the member of the support team, the program director if the individual desires additional assistance.

26. The method of claim 25, further comprising the step of:
recording, via the program director, the type of assistance that is being provided to the individual.

27. A method for implementing a program within a business community to assist in the treatment of a plurality of medical conditions, comprising:
creating an internal support network to operate the program;
determining which particular medical conditions are going to be stressed within the program;
proactively compiling medical information concerning the particular medical conditions according to a desired standard of review;
assembling the compiled medical information for each particular medical condition into an individual guide for the particular medical condition; and
maintaining the assembled medical information so that the assembled medical information meets the desired standard of review.

28. A method of claim 27, the creating step further comprising the steps of:
recruiting a support staff from the business community to operate the program; and
providing a training program for teaching the support staff how to operate the program.

29. The method of claim 28, wherein a portion of the support staff include persons from the business community who have survived one of the particular medical conditions.

30. The method of claim 27, further comprising the steps of:
maintaining, via the support staff, an inventory of individual guides for the particular medical conditions; and
providing personal assistance, via the support staff, in understanding the resource guides.

31. The method of claim 27, the proactively compiling step further comprising the steps of:
for each particular medical condition, searching for information on the medical condition;
reviewing the information obtained from the searching step to determine if the information meets the desired standard of review;
obtaining permission to use the information that meets the desired standard of review; and
procuring the information that meets the desired standard of review.

32. The method of claim 27, the assembling step further comprising the steps of:
gathering the information that meets the desired standard of review into a compilation of information for the particular medical condition;
duplicating the compilation of information;
storing an inventory of the compilation of information for the particular medical condition; and
distributing the compilation of information for the particular medical condition to an individual who has requested assistance for the particular medical condition.

33. The method of claim 32, the assembling step further comprising the steps of
providing a talking book version of the compilation of medical information by extracting information from the compilation of information for the medical condition onto an audio storage device for audio playback; and
distributing the talking book version to an individual who has requested the talking book version.

34. The method of claim 27, further comprising the steps of publicizing the program through business channels;
soliciting feedback on program effectiveness from participants in the program; and
maintaining utilization data from the participants to track program effectiveness.

35. A system for implementing a program that provides assistance in managing a medical treatment within a business environment, comprising:
a local information network provided within the business environment to disseminate information from the program to an active member of the business environment, wherein the information includes a description of services provided by the program, a request for support from active members, and a mailbox address;
a community network provided outside the business environment to disseminate additional information from the program to a person that is not an active member of the business environment, wherein the additional information includes the description of services provided by the program, a request for support from persons that are not active members, and a mailbox address to a mailbox address; and
an electronic mailbox to store messages from persons that are attempting to contact a representative of the program at the mailbox address.

36. The system of claim 35, wherein the electronic mailbox is a voice mailbox.

37. The system of claim 35, wherein the electronic mailbox is an email mailbox.

38. The system of claim 35, further comprising:
an Internet server to store a web site for the program, wherein the web site contains a description of services performed by the program that is tailored towards a group of persons from whom the program is interested in obtaining support.

39. The system of claim 38, wherein the support comprises volunteer services.

40. The system of claim 38, wherein the support comprises a monetary gift.

41. The system of claim 35, wherein the local information network comprises:
a private messaging network that is utilized by the active members.

42. The system of claim 35, wherein the local information network comprises:
a video monitoring system to display video information to the active members.

43. A system for implementing a program that provides assistance in managing a medical treatment within a business environment, comprising:
a general assistance component to disseminate unsolicited information to members of the business environment;
a special assistance component to provide requested assistance to members of the business environment;
a management component to oversee operations of the program;
a maintenance component to provide continual support services to the program;
an information network to propagate communication from the program throughout the business environment; and
a mailbox to receive communication directed to the program from members of the business environment.

44. The system of claim 43, wherein the management component and maintenance component comprises members from the business environment.

45. The system of claim 44, wherein the management component and maintenance component further comprise members from outside the business environment.

46. The system of claim 43, wherein the information network further communicates with retired members of the business environment who are eligible to receive assistance from the program.

47. The system of claim 43, wherein the maintenance component and special assistance component further comprise a plurality of subcomponents, each respective subcomponent assigned to perform a respective task.

48. The system of claim 47, wherein the plurality of subcomponents comprise:
a first subcomponent that obtains current information that is to be included in a resource guide of medical information;
a second subcomponent that assembles the resource guide of medical information;
a third subcomponent that assures that information contained in the resource guide is current; and
a fourth subcomponent that provides personal assistance to eligible persons.

49. The system of claim 47, wherein the management component comprises a respective leader of each respective subcomponent.

50. The system of claim 47, wherein the management component comprises at least one leader of a respective subcomponent that has survived a medical condition to which the respective subcomponent supports.

51. The system of claim 43, wherein the management component comprises a training coordinator in charge of instructing the support staff; a volunteer coordinator in charge of managing volunteers; and a representative from another program that works in collaboration with the present program.

52. The system of claim 43, further comprising:
a database to store a record of the tasks that are performed by components of the program and the current organizational structure of the program.
